(19) United States
(12) Patent Application Publication
(10) Pub. No.: US 2002/0138839 A1
(43) Pub. Date: Sep. 26, 2002

(54) Periodic media segment charging apparatus and method thereof

(76) Inventor: Perwaiz Nihal, Fishkill, NY (US)

Correspondence Address: KENYON & KENYON, ONE BROADWAY, NEW YORK, NY, 10004, US

(21) Appl. No.: 09/815,640

(22) Filed: Mar. 23, 2001

(51) Int. Cl. G06F 15/16; G06F 7/00; G06F 17/30; H04N 7/16; H04H 9/00; G06F 3/00; H04N 5/445; G06F 13/00; G06F 17/60

(52) U.S. Cl. 725/60; 709/203; 707/10; 709/217; 725/37; 725/9; 709/219; 705/26

(57) ABSTRACT

An apparatus and method for periodic media segment charging. More particularly, an apparatus records media segments, and plays them either in a random or assigned pattern, as programmed or desired by a user or the provider. After a preprogrammed limit, the apparatus can be recharged for the same or a different media segment selection.

### FIELD OF THE INVENTION

An apparatus and method for periodic media segment charging is disclosed. More particularly, the invention encompasses an apparatus that records media segments, and plays them either in a random or assigned pattern, as programmed or desired by a user or the provider. After a preprogrammed limit the apparatus can be recharged for the same or a different media segment selection. A method for such charging and recharging is also disclosed.

### BACKGROUND INFORMATION

The freedom of the Internet has provided tremendous opportunities. For example, one is free to browse the Internet and get all sorts of data and other information without having to pay for it, except for some nominal charges, such as, for example, the connection charge and/or paying an amount to an Internet provider to become a subscriber in order to be able to access the Internet. However, in this stream of commerce from the originator to the end user someone has to financially support this stream of commerce.

Various companies are developing streaming media networks using various communication links to deliver bandwidth intensive Internet content using the currently available broadcast technology in conjunction with the existing Internet protocols.

### SUMMARY OF THE INVENTION

This invention combines broadcasting with the various Internet protocols to deliver multimedia content. The apparatus and process of this invention allows for quality of service and unrestricted scalability in multimedia content delivery. The user's experience approaches the quality expected in traditional broadcasting, yet the user's potential breadth of content selection is very extensive.

The system also allows selective acquisition and aggregation of desirable audio and video programming from around the world. Special interest channels can also be integrated or provided.

By establishing POPs (points of presence) at Internet access providers, including, cable head-ends, digital subscriber line (“DSL”) providers' central offices, Internet service providers' (“ISPs”) local POPs and multiple dwelling units such as office buildings (“Risers”), this invention is able to serve these POPs by delivering bandwidth intensive content over a commercial communications transmission system.

The invention also allows the integration into its content delivery network a conditional access system which allows the content providers within the Internet, and broadband Internet access providers at the “edge” of the Internet, to control the flow of data at each of their respective ends of the delivery channel to end users. As part of its technology solution, the system has the ability to encrypt data over its network which enables the content providers and Internet “edge” providers to offer demographically targeted content, subscription services and pay-per-view content, thereby enhancing the value of advertising accompanying such content. This invention through its network is capable of delivering both streaming multimedia and large data objects to millions of destinations and targets both the consumer and business markets simultaneously.

This invention provides value to the entire Internet multimedia chain from content providers, through network access providers and ultimately the end user. Thus this invention allows the freedom of the Internet and combines it with a revenue stream so that all parties benefit from the transactions.

Therefore, one purpose of this invention is to provide an apparatus and a method that will record media segments, and plays them either in a random or assigned pattern, as programmed or desired by a user and/or the provider.

Another purpose of this invention is to provide an apparatus in which after a preprogrammed limit the apparatus can be recharged for the same or different media segment selection.

Leveraging the point-to-multipoint nature of broadcasting this invention system can cost effectively deliver radio and TV quality audio and video streaming media to points of presence (“POPs”) where Internet end users connect to the Internet, commonly referred to as the “edge” of the Internet.

The present invention provides a method of transferring information to a remote apparatus having a storage device, comprising:

(a) linking the remote apparatus to a data base containing user selectable information and provider defined information;

(b) selecting and transferring at least a portion of the provider defined information to the remote apparatus; and

(c) selecting and transferring at least a portion of the user selectable information to the remote apparatus.

In another aspect this invention comprises a program storage device readable by a machine, tangibly embodying a program of instructions executable by the machine to perform method steps for transferring information to a remote apparatus having a storage device, the method steps comprising:

(a) linking the remote apparatus to a data base containing user selectable information and provider defined information;

(b) selecting and transferring at least a portion of the provider defined information to the remote apparatus; and

(c) selecting and transferring at least a portion of the user selectable information to the remote apparatus.

In yet another aspect this invention comprises a system for providing access to media segment information on a computer with a web browser from a data storage system accessible by a web server, the system comprising: a program for making available the information from the data storage system; and a file system attachment in a URL including a name of a desired file system, a location of the desired file system, and an identification of the program for making available the desired file system; wherein a data base containing the desired file system is directly contacted utilizing the program and the name and the location of the desired file system to locate the desired file system containing the media segment information.

In still another aspect this invention comprises a system for transferring media segments to a web client computer from a web network computer, comprising:

(a) at least one data base at the web network computer containing media segment information accessible from at least one network;

(b) means for determining from the web network computer data base the media segment information; and

(c) means for transferring into the web client computer at least a portion of the media segment information from the web network computer.

In still yet another aspect this invention comprises an apparatus for transferring information to at least one user, comprising:

(a) a central system having user selectable information and provider defined information;

(b) a remote apparatus having a storage device;

(c) means for linking the remote apparatus to the central system; and

(d) means for transferring the provider defined information to the remote apparatus and for transferring the user selectable information to the remote apparatus.

In another aspect this invention comprises a system for transferring media segments to a portable device from at least one web network system comprising:

(a) at least one data base on the web network system containing at least one media segment accessible from at least one network;

(b) means for determining from the data base on the web network system information on the media segment; and

(c) means for transferring to the portable device at least a portion of the media segment from the web network system.

In yet another aspect this invention comprises a system for transferring media segments to a portable device from at least one web network system comprising:

(a) at least one data base on the web network system containing at least one media segment accessible from at least one network;

(b) means for determining from the data base on the web network system information on the media segment; and

(c) means for transferring to the portable device at least a portion of the media segment from the web network system via at least one distributor network.

In still another aspect this invention comprises a method of transferring information to a remote portable device, comprising:

(a) linking the remote portable device to a data base containing user selectable information and provider defined information via at least one distributor network;

(b) selecting and transferring at least one of the provider defined information and distributor defined information to the remote portable device; and

(c) selecting and transferring the user selectable information to the remote portable device.

### BRIEF DESCRIPTION OF THE DRAWINGS

FIG. 1 illustrates a preferred embodiment of this invention.

FIG. 2 illustrates another embodiment of this invention.

FIG. 3 illustrates yet another embodiment of this invention.

FIG. 4 illustrates a flow chart of the preferred method of this invention.

### DETAILED DESCRIPTION OF THE INVENTION

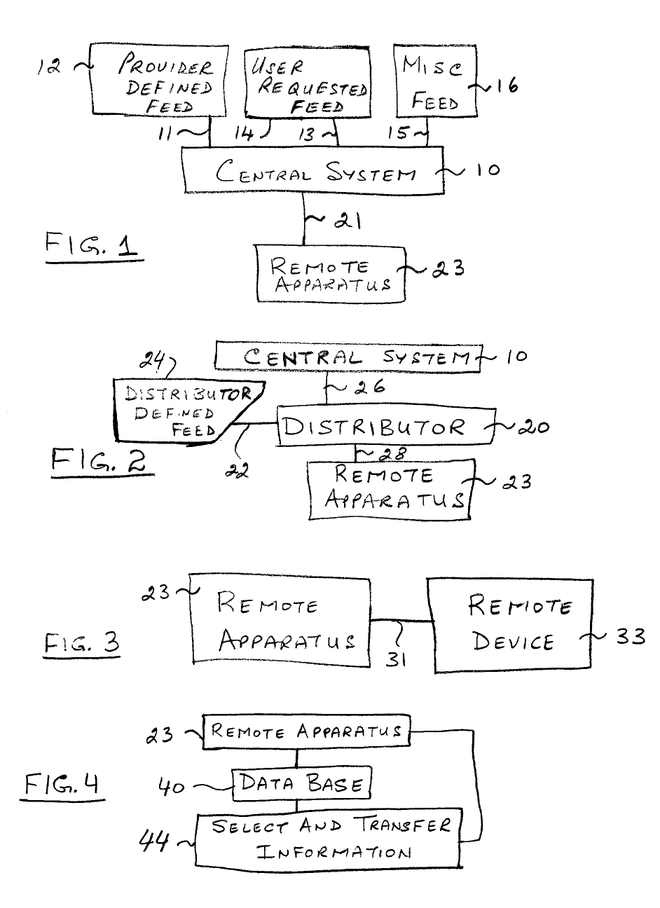

FIG. 1 illustrates a preferred embodiment of this invention, where a central system 10 has at least one link 11 to a provider defined feed 12, at least one link 13 to a user defined feed 14, and with an optional link 15, to at least one miscellaneous feed 16. At least one link 21 connects a remote apparatus or device 23 to the central system 10.

As shown in FIG. 1 a user links his remote apparatus 23, such as, his player 23, to the central system 10. If it is the first time that the central system 10 has been approached by the user and/or the player 23 the system 10 could create a user and/or a player profile. The user and/or the player profile could be located inside the player 23, or it could be located inside the cental system 10, or it could be at any other location.

The user having the remote apparatus 23, initially links his apparatus 23, to the central system 10. After the initial set-up the system 10 gives the user a complete or a limited access to all contents in the feed 14. The user, for example, is only interested in downloading a series of musical segments and a series of video clips from the feed 14. The system 10, could also allow the user to sample some of the contents from the feed 14, before making any selection. After the user has made at least one selection the system 10 starts allowing the duplication of that selection onto the remote apparatus 23. This duplication of content from the feed 14, could be after each selection or upon completion of the transaction. This process continues until either the user is satisfied with the selection(s) or the memory for the user requested feed into the remote apparatus is full.

While the user is duplicating the contents from the feed 14, the system 10, could be transferring or duplicating media contents from the provider defined feed 12, and/or the miscellaneous feed 16. For example, along with the musical segments and video clips that the user had requested from the feed 12, the system 10, could also download a series of media segments, such as, for example, advertisements, from the provider defined feed 12, and/or the miscellaneous feed 16.

The system 10, can be programmed so that the user will have a choice to listen and/or view the downloaded media segments from the provider defined feed 12, and/or the miscellaneous feed 16, such as, advertisements, and then selecting some and deselecting others. This could be done at each transaction or at the beginning of the transaction or at the end of the transaction or at any point in between.

Once the user is satisfied with his selection from the feed 12, and the selection from the provider defined feed 14, and/or the miscellaneous feed 16, the user can then start using his device 23 for a set period of time or until it is time for recharging.

FIG. 2 illustrates another embodiment of this invention, where a distributor 20 is an intermediate electronic apparatus 20 between the central system 10 and the remote apparatus 23. Link 26 connects the distributor 20 to the central system 10, while link 28 connects the distributor 20 to the remote apparatus 23. A distributor defined feed 24 can be provided to the remote device 23 in a number of ways, such as, via a connection 22 to the distributor 20.

FIG. 3 illustrates yet another embodiment of this invention where the remote device/apparatus 23 is linked to another remote device/apparatus 33, via at least one link 31. The remote devices 23 and 33 may be the same or could be different.

Each of the links 11, 13, 15, 21, 26, 28, 31, . . . , could be hard-wired or wireless.

FIG. 4 illustrates a flow chart of the preferred method of this invention where the remote apparatus 23 having a storage device is linked to a data base 40 containing the user selectable information and provider defined information. At step 44, the user selects and transfers at least a portion of the provider defined information to the remote apparatus 23, and can also select and transfer at least a portion of the user selectable information to the remote apparatus 23.

The remote apparatus or the player 23 could be given away or leased or rented or sold for a nominal price. In each instant it could be encoded so that it only operates with embed segments from either an authorized distributor 20, or the central system 10. The remote apparatus 23, could even be given away as a promotional item, so that in some cases the user may never have to pay for the playing device 23, as long as the user has it charged using the contents from the distributor 20 or the central system 10.

The device or the player 23 can be any hand-held type of a device or it could be a part of a computer device, or it could be a part of any other electronic device that may or may not be completely portable. However, it is preferred that the device 23 is portable and linkable to another electronic device, and with direct or indirect access to a network, such as, the Internet.

In each case the device 23 could have instructions from the system 10, and/or the distributor 20, to play a fixed number of times or for a fixed time period, and to either stop playing or give at least one warning to the user that the device 23 is now ready for recharging.

The remote apparatus 23, could be set-up in a number of ways. For example, one way could be to have a number of provider defined segments play a number of times. For example, it could be say thirty ads and a different ad could be played every time the user played a segment of his choice, such as, a song, or each time a different ad could be played. Or one could even give the user the option of skipping a certain ad or a certain number of ads. However, for some applications it may be preferred that the user listen to other ads in place of the ones being skipped in order to continue using the device 23 or the system 10. Using this system the user could even provide feedback on what is not acceptable advertising, or what is offending people or what the users like or do not like about the provider defined feed. All this information could be noted and sent back to the appropriate individuals or entities, such as, the providers, sponsors, special interest groups, to name a few.

However, in case there is resistance or reluctance to all those provider defined feed 12, by the user then the device 23 could stop playing the user requested feed 14, such as, music, and the remote apparatus 23, could only be activated upon, say recharging the player or the device 23. Upon recharging the remote apparatus 23, the user could get a whole new set of ads, along with the desired selection of segments. This way the user gets to listen to the music that they like, as well as, to the ads that are supporting the free downloading or allowing the playing of free music or watching their favorite TV program one or more times.

Similarly, the programing for the remote apparatus 23 could be very flexible, as far as how long a segment could be played or when it could be played. For example, one could program the apparatus 23, so that the provider defined segment could be played at the beginning or at the end of each user defined selection or that it could start playing, for say, a five seconds period or a 15 seconds segment, in a preselected or some random manner.

The system 10 or the distributor 20 could allow the device 23 as much time as needed or preselected before any recharging. This could allow the user the benefit of playing the audio and/or the video segments over and over again, along with the provider defined media segments to played for this preselected or predefined time period. As discussed elsewhere this invention also allows for the user to remotely carry the device 23, to copy the contents from the device 23, to distribute the contents of the device 23, within a set of user and/or provider defined parameters. Similarly, the system of the device 23 can be programmed to have a set of fixed number of playbacks or a variable playbacks. Once the term of the fixed playbacks or variable playbacks has expired then the device 23 could prompt the user to have the device 23 recharged. For example, if one or more of the segments have been played, lets say 100 times, the user may have to go to a recommended site 10 or 20 to recharge the device 23. During this recharging the user could, either keep the previous sets of user selected material or could get new materials. Similarly, the user could keep the previous sets of provider defined segments or download new provider defined segments. Of course the old or the new segments or a combination of the two coming from the system 10 or distributor 20 could get incorporated into the segments that are being downloaded or being transferred onto the device 23. Here again the user could also have the choice to pick up the number of times he wants the segments to be played or their duration.

During this recharging process the system 10 or the distributor 20 could reset any counter, note any address, or obtain any desired information about the user and/or the player 23, such as, for example, at what time the user listens to one or more of the segments, which segments and/or ads that he is skipping, the duration of each listening and/or viewing session, the sharing or transferring of one or more media segments.

However, if a consumer was satisfied with their current selection they could just simply recharge the apparatus 23, without having to perform the select and deselect process. Similarly, during the initial charging process or any subsequent recharging step the consumer could request that their player 23 be setup to play lets say, 20 times, 500 times, 10,000 times or let say for 20 hours, 500 hours, 10,000 hours. This could be one way to delay the periodic frequency of charging the player 23.

Similarly, the system 10 or the distributor 20 or the player 23, could be setup in such a way so that if the device 23 was not recharged after giving the user one or more warnings the player 23 could be programed to stop playing until it is recharged.

The recharging time and any other provider and/or user preferences could be set-up at anytime. For example, these could be done at the first downloading time or it could be done at any subsequent recharging time. Similarly, the number or period of recharging could be fixed or it could be variable. The recharging warning could be set by a central location or by a dealer or a distributor or be contained within the device 23. Therefore, the system has been made as flexible and as user friendly as technologically possible.

For the recharging of the device 23 one can even make it so that it constantly or periodically asks the user if the user want it to be automatically recharged or be charged at a certain time. This could be done, for example, when the user is browsing the web. Then the player or the device 23 could be automatically recharged without the user even participating in the process. This feature could preferably be limited to the provider defined feed 12, so that the user requested feed 14 is not disturbed or affected. This recharging could be done in the background without the user even knowing about it. However, in each case the user may have to identify their preferences for the player 23, so that the device 23, or the system 10 or the distributor 20 knows the recharging preferences for the user with the apparatus 23.

The recharging information could be contained within the unit 23 or it could be held by the system 10 or the distributor 20. Similarly, this information could be on a disk or any other media or any other secure location as long as it is retrievable upon need or request.

The user may be free to update their profile and/or preference and/or selections using the device 23. The user can request new ads or segments, for example, during a particular promotion so that their chances of winning are increased. Similarly, the device 23, could be set-up in such a way that when the user makes a connection to a network the device 23 automatically gets recharged. The user could have completely new ads sprinkled into the player 23 or the user could select certain ads or segments while deselecting others or any combination of selection and deselection of the ads. This becomes important as one users preferences might be different than a second user, for example, a male user may not have any interest in ad segments directed towards the female audience, similarly, an older audience will have little interest in ad segments directed to a younger generation, even though they may have the same or similar preferences in the user requested feed selection.

During the downloading or transfer process the audio segment and/or the video segments could also have a sprinkling of advertising by local and/or regional and/or national advertisers, which could be coming from the system 10 and/or the distributor 20.

Similarly, if the user requested feed 14, is an audio segment, such as, for example, a song, the provider defined feed 12, could also be an audio segment of similar nature, such as, a jingle. The apparatus 23, could also be encoded and/or embed with any advertisement segments that are activated by a code that is generated. This code could come from a variety of sources, such as, particular phrases contained in the user requested feed 14 or it could be time generated or they could be randomly generated from another source, such as, the Internet. However, only the users having the player 23 or the portable device 23 are able to play and/or view it.

The selection or charging of the device 23, could be a partial or a complete charging. For example, if the user is using the Internet to download or retrieve some information they could go to any recommended site and click on the desired media segments that they are interested in retrieving, such as, for example, music clips, songs, video clips, audio clips, books on tape, musical compositions, TV programs, movies, to name a few, and transfer the desired segments onto their device 23. During this transfer process the player 23, sets aside a portion of the memory space for the media segments from the providers or sponsors or advertisers. The media segments from the provider defined feed 12, could be a banner ad which is a clickable feature or a banner ad or an interactive ad or an audio or video media segment. The segments from the provider defined feed 12 could be embedded in the beginning or in the end of the program or they could be sprinkled throughout the program in a random or any defined manner.

The device 23 could be provided with a code, such as, a PIN (personal identification number) code, so that only the person with the PIN code could operate the player or device 23 or be able to access the system 10 and/or the distributor 20. Similarly, one or more steps in the charging and/or transfer process could be with or without an encryption process. This encryption process provides privacy and/or security for all the parties in the link. The player 23 can also be set2 up so that it can decrypt the music and play it together with the ad.

It is preferred that the user be free to share the contents of the device 23 with anyone. The device 23 allows the user to take it anywhere, play it anywhere, listen to the music, view their favorite program, access the Internet, listen and/or view audio and/or video segments while having the provider defined media segments as a part of the download or transfer.

The recharging process could update the player 23 at anytime at any place where the device 23 is able to link up with the distributor 20 and/or system 10. The system 10 could allow the provider 12 to randomly broadcast the media segments to the player 23 so that the consumer does not get tired of listening or viewing the same media segments while still enjoying the user requested media segments.

The recharging process also allows the provider 12 of the player 23 to obtain a feedback as to how many times the player 23 has been played, or which segments were listened to and/or viewed and for how long. For example, was a certain media segment skipped at a certain point or was that segment played back a number of times or was a particular section rewinded a certain number of times. The device 23 could also be a recording mechanism informing the provider 12 that the player 23 has been played, say 2324 times.

Similarly, even when the media segments are changed by the user it still provides the provider 12 with useful information, such as, for example, the provider might become aware of which ads are boring or which ads are not being acceptable by a certain demographic, etc.

During the selection process the user can pick media segments, such as, a list of songs, or they can get more premium music, but they may have to register for it. This way the provider 12 will know exactly what the user received and/or what is the origination of a certain media segment if and when it is transferred, say, to another user. Therefore, when the users come to recharge, the distributor 20 or the system 10 now knows who has the new media segment and they could keep track of both the provider defined segments 12 and the user requested media segments 14 through the recharging method.

So if the first user passed or gave the segment(s) to another user or if the second or subsequent user downloaded onto their equipment 33 then that could be fine, because once they make a partial or a complete copy and play it a number of times the subsequent user will eventually have to go for the recharging step. Furthermore, because it is a copy and it has already been played a number of times by the original user and therefore any subsequent copies will have to be recharged for any subsequent playing of the media segments. So theoretically, the original user could make as many copies of her downloaded item as many times that she wanted, however, the copies have to be recharged or upon expiration the new segments on any player have to be recharged. So, one could have lets say three copies playing at the same time, at the same or at a different location, and by the same user or different users.

For example, user one has the player 23 with music on it. User one can then make copies of the music and give it to one or more of her friends. Her friends have to have a compatible player 33. Therefore, when the user plays the various segments or when the second user comes in for recharging, the player knows that this is a new player playing. At that point the second user could have a series of options, one such option could be either to make the second user go to a web-site to register or letting the second user have a number of free plays, and then asks him to go to a particular web-site for recharging.

This invention provides security for the creative work while allowing it to be shared with any other users. It provides another advertising avenue so that the artists can be correctly compensated for their creative work every time the user comes back for recharging, as the provider now know that a certain song has been played, say, 200 times, and lets say the artist get a penny for each time that particular song is played by the user.

Similarly, a portion of the revenues coming from the provider or advertiser 12 could be going to the distributors 20. This could again depend upon the number of times a particular media segment or a song has been played and a particular media segment or an ad has been played.

The monies could be coming from the advertisers, while the monies can be shared by the distributor(s) and a portion of it could be going to the artist. Therefore, if an artist is more popular, then they could be making more money off this invention, even though they are not themselves, making a disk and sending it out themselves, as the user or the listener is actually downloading and selecting the songs or any media segment.

Therefore, the more number of number of times the song is played, the more money the artist can make. And, of course the distributer, advertisers and other individuals could be getting more information about the user, their demographics, their preferences, etc.

Similarly, the advertisers can also get their desired information so that they could target their advertising to the users who have seen or heard their ads the most.

Similarly, for some small compensation the advertisers could even ask the users to complete a survey to better understand that particular market segment.

This invention allows the users to enjoy the media content that they like to listen and/or view to while allowing the provider to target a certain segment of the population with their desired contents, such as, advertising. Additionally, it allows the true owner of the media content to not only be recognized but to also get compensation for their creative work which is directly proportional to how their media content is accepted by the consumers or end users. Furthermore, it also gives the providers or the sponsors to not only target their market but only pay for it, for example, through the for advertisements, that are being listened to by the consumers. Similarly, the sponsors or advertisers whose ads are not being accepted by the consumer could get a prompt feedback of their product and/or message.

It should also be understood that the provider defined information could be selected from a group comprising issues of local, regional and national concern, which may include, but is not limited to, advertising, political issues and announcements, public service announcements, religious announcements, to name a few, which of course can also be a user selectable feature.

This invention allows the creation of a revenue stream for the artists and producers and it could be available, for example, on the Internet, for people to copy as many times as they want or to pass it to their friends.

### EXAMPLES

The following examples are intended to further illustrate the invention and are not intended to limit the scope of the invention in any manner.

### Example 1

Perwaiz a user could use his portable device 23 to download a series of musical segments and video clips that he wants to view. Along with these musical segments and video clips the system 10 could also download a series of advertisements. Perwaiz will have a choice to listening and/or viewing the downloaded advertisements and then selecting some and deselecting others. He could do this during the first link or at any subsequent link. After linking his remote apparatus 23, to the central system 10 or the distributor 20 he could remove the deselected items, such as, advertisements, and replace them with another set of selected items, such as, a new set of advertisements. Perwaiz could either accept the new selection or go through the selection and deselection process as long as he wanted to. Once he is satisfied with the advertisements that have been selected, either by him or the system 10 or the distributor 20, he can start using his portable device 23 for a period of time until it is time for recharging.

### Example 2

While playing his portable device 23 Perwaiz a user comes across his friend Nihal. Nihal listens and/or views Perwaiz's selections of video clips and/or musical segments and wants to download some or all of them onto her portable device 33. She links her device 33 and selects one or more items to be downloaded onto her device 33. However, with this process a series of advertisements could also be transferred from Perwaiz's portable device 23 onto Nihal's device 33. If Nihal is not interested in some of the advertisements that have been downloaded she can link her portable device 33 to the central server 10 or to a distributor 20 and select and deselect the musical segments and/or video clips and/or the advertisements. She can then listen to and/or view her selection on the remote apparatus 23, for a fixed or preselected number of times.

### Example 3

While Perwaiz and Nihal were selecting and deselecting their musical segments and/or video clips and/or the advertisements, the central server 10 or the distributor could also be observing and recording the exchange. This exchange could be used to let the different providers and/or advertisers become aware of which of their segments and/or ads are acceptable or liked or tolerated by the consumers or end users and which of them are constantly being deselected. Any kind of fine segmentation of these exchanges or transactions are possible, such as, male or female selections or deselections, the different age demographics of the users, the economic demographics, to name a few. Similarly, these selections and deselections process could also be used to compensate the different artists and producers of the various segments, such as, musical segment and/or video clips.

While the present invention has been particularly described, in conjunction with a specific preferred embodiment, it is evident that many alternatives, modifications and variations will be apparent to those skilled in the art in light of the foregoing description. It is therefore contemplated that the appended claims will embrace any such alternatives, modifications and variations as falling within the true scope and spirit of the present invention.

What is claimed is:

1. A method of transferring information to a remote apparatus having a storage device, comprising:
(a) linking the remote apparatus to a data base containing user selectable information and provider defined information;
(b) selecting and transferring at least a portion of the provider defined information to the remote apparatus; and
(c) selecting and transferring at least a portion of the user selectable information to the remote apparatus.

2. The method of claim 1, wherein the linking is performed using at least one of a cable line, a telephone line, a wire line, a fiber optic line and an electrical line.

3. The method of claim 1, wherein the linking is performed using wireless.

4. The method of claim 1, wherein a device provider's data base randomly selects a series of provider defined information transmitted to the apparatus.

5. The method of claim 1, wherein a device systematically selects a series of information transmitted to the apparatus.

6. The method of claim 1, wherein the user randomly selects a series of items transmitted to the apparatus.

7. The method of claim 1, wherein the user systematically selects a series of items transmitted to the apparatus.

8. The method of claim 1, wherein a device linked to the apparatus randomly selects a series of items transmitted to the apparatus.

9. The method of claim 1, wherein a device linked to the apparatus systematically selects a series of items transmitted to the apparatus.

10. The method of claim 1, wherein the user duplicates information from the remote apparatus into a further remote apparatus.

11. The method of claim 1, wherein a device tracks the usage of information on the apparatus.

12. The method of claim 1, wherein the information is transferred in an encrypted manner.

13. The method of claim 1, wherein the apparatus has at least one auxiliary output.

14. The method of claim 13, wherein the auxiliary output is selected from a group consisting of an ear phone, an external speaker, and an electrical, electromechanical, optical and video device.

15. The method of claim 1, wherein the transferred information includes at least one of audio, video, visual format, executable code and data.

16. The method of claim 1, further comprising the step of executing a media segment a predetermined number of times.

17. The method of claim 1, further comprising the step of executing a plurality of media segments for a predetermined time period.

18. The method of claim 1, further comprising the step of recharging the storage device during one of an active mode, a suspend mode and a sleep mode.

19. The method of claim 1, wherein a portion of the transferred segment is played at least once.

20. The method of claim 1, wherein a portion of the transferred segment is played at least once, and any subsequent playing is at a user's request.

21. The method of claim 1, wherein at least one segment is played at least once.

22. The method of claim 1, wherein at least one segment is played at least once, and any subsequent playing is at a user's request.

23. The method of claim 1, wherein the user selectable information is selected from a group consisting of music clips, video clips, audio clips, songs, books on tape, musical compositions, TV programs, movies and multimedia projections.

24. The method of claim 1, wherein the provider defined information is selected from a group consisting of local, regional and national concern.

25. The method of claim 1, wherein the provider defined information is selected from a group consisting of a banner ad, an interactive ad, an audio ad, a video ad and a multimedia ad.

26. The method of claim 1, wherein during a recharging process information from said apparatus is transferred to the data base.

27. The method of claim 26, wherein compensation for an individual is directly related to the information transferred.

28. The method of claim 26, wherein the transferred information includes at least one of a feedback survey, a user preference, a user demographic, compensation for provider defined information and compensation to a provider of user selectable information.

29. A program storage device readable by a machine, tangibly embodying a program of instructions executable by the machine to perform method steps for transferring information to a remote apparatus having a storage device, the method steps comprising:
(a) linking the remote apparatus to a data base containing user selectable information and provider defined information;
(b) selecting and transferring at least a portion of the provider defined information to the remote apparatus; and
(c) selecting and transferring at least a portion of the user selectable information to the remote apparatus.

30. A system for providing access to media segment information on a computer with a web browser from a data storage system accessible by a web server, the system comprising: a program for making available the information from the data storage system; and a file system attachment in a URL including a name of a desired file system, a location of the desired file system, and an identification of the program for making available the desired file system; wherein a data base containing the desired file system is directly contacted utilizing the program and the name and the location of the desired file system to locate the desired file system containing the media segment information.

31. The system of claim 30 wherein the program is resident on a client computer system.

32. The system of claim 30 wherein the program is resident on the web server.

33. The system of claim 30 wherein the file system attachment includes a user identification, the user identification being adapted to control access to the desired file system.

34. The system of claim 30 wherein the URL is provided in a web page accessible through the web server.

35. A system for transferring media segments to a web client computer from a web network computer, comprising:
(a) at least one data base at the web network computer containing media segment information accessible from at least one network;
(b) means for determining from the web network computer data base the media segment information; and
(c) means for transferring into the web client computer at least a portion of the media segment information from the web network computer.

36. An apparatus for transferring information to at least one user, comprising:
(a) a central system having user selectable information and provider defined information;
(b) a remote apparatus having a storage device;
(c) means for linking the remote apparatus to the central system; and
(d) means for transferring the provider defined information to the remote apparatus and for transferring the user selectable information to the remote apparatus.

37. A system for transferring media segments to a portable device from at least one web network system comprising:
(a) at least one data base on the web network system containing at least one media segment accessible from at least one network;
(b) means for determining from the data base on the web network system information on the media segment; and
(c) means for transferring to the portable device at least a portion of the media segment from the web network system.

38. A system for transferring media segments to a portable device from at least one web network system comprising:
(a) at least one data base on the web network system containing at least one media segment accessible from at least one network;
(b) means for determining from the data base on the web network system information on the media segment; and
(c) means for transferring to the portable device at least a portion of the media segment from the web network system via at least one distributor network.

39. The system of claim 38, wherein the at least one distributor network defines at least one distributor define feed.

40. A method of transferring information to a remote portable device, comprising:
(a) linking the remote portable device to a data base containing user selectable information and provider defined information via at least one distributor network;
(b) selecting and transferring at least one of the provider defined information and distributor defined information to the remote portable device; and
(c) selecting and transferring the user selectable information to the remote portable device.
